(19) United States
(12) Patent Application Publication
(10) Pub. No.: US 2023/0053922 A1
(43) Pub. Date: Feb. 23, 2023

(54) SYSTEM AND METHODS FOR EFFICIENT PARKING AND CHARGING OF ELECTRIFIED VEHICLES

(71) Applicant: The Regents of the University of California, Oakland, CA (US)

(72) Inventors: Francesco Borrelli, Kensington, CA (US); Scott J. Moura, Berkeley, CA (US); Xu Shen, Albany, CA (US); Soomin Woo, Albany, CA (US)

(21) Appl. No.: 17/821,418

(22) Filed: Aug. 22, 2022

Related U.S. Application Data
(60) Provisional application No. 63/260,484, filed on Aug. 20, 2021.

(51) Int. Cl. G06Q 10/04; B60L 53/68; G08G 1/14; G01C 21/34; B60L 53/62; G06Q 10/02; G06Q 50/06

(52) U.S. Cl. CPC G06Q 10/04; B60L 53/62; B60L 53/68; G01C 21/3476; G06Q 10/02; G06Q 50/06; G08G 1/14

(57) ABSTRACT

A system can include: a detector configured to provide input information; an electric vehicle; an electric vehicle charger; and a cloud server configured to execute a Simultaneous Parking and Charging Management (SPCM) method based on the input information, and communicate with the electric vehicle to assign a time for a certain electric vehicle charger based on a result of the executed SPCM method.

### CROSS-REFERENCE TO RELATED APPLICATION

The present application claims priority to U.S. Provisional Application No. 63/260,484, entitled “SYSTEM AND METHODS FOR EFFICIENT PARKING AND CHARGING OF ELECTRIFIED VEHICLES”, filed on Aug. 20, 2021. The entire contents of the above-listed application are hereby incorporated by reference for all purposes.

### BACKGROUND AND SUMMARY

Parking vehicles and charging Electric Vehicles (EVs) are universal problems in most cities with a large EV presence. Looking for a parking and charging spot leads to an inefficient use of energy, a higher cost in charging EVs, higher emissions, and a slow market adoption of EVs. Currently, parking and charging systems operate far from optimal, since the drivers can only manually check the occupancy by driving through the parking facility and searching the available spots one by one. During this process, they might run into heavy traffic or compete with other drivers for certain spots, significantly wasting time and energy. Also, the energy demand in charging EVs exacerbates the burden on the energy grid system. Due to range anxiety, EV drivers often choose to charge at full power immediately upon arrival, often in the evening after they return from work. This may decrease clean energy use, increase greenhouse gas emissions, and increase the grid operation cost. Moreover, the EV drivers often overstay at a charging spot after finishing to charge and prevent others from using them. This inefficient use of parking and charging infrastructure will prevent the facility from serving more vehicles, and the poor reliability of charging infrastructure will impair a rapid growth in market adoption of EVs.

Embodiments of the disclosed technology can address the problems of managing the charging and parking of vehicles with the goal of reducing the energy consumption, reducing the greenhouse gas emissions, increasing the clean energy consumption, and enhancing charging reliability. Since EVs need to park while charging, the parking and charging problems are naturally linked to one another. Certain embodiments simultaneously solve the parking and charging problems and can: reduce the total energy consumption and greenhouse gas emissions by assigning vehicles the location and time schedule of parking/charging spots; and increase the clean energy use by optimizing the charging time and charging power of EVs.

If the vehicles are equipped with an autonomous driving stack, embodiments can also: provide optimal trajectories (i.e., path and velocity) and control the vehicles to maneuver to the parking/charging spots in an efficient manner, without human drivers’ presence, time, or effort; and reduce the idle capacity of chargers and enhance charging reliability by autonomously relocating the EVs that have finished charging.

As a result, the improved environmental, social, and governance (ESG) performance will benefit the individual drivers, the facility operators, and the ecology system on the earth. Certain embodiments of the disclosed technology are also referred to herein as the Simultaneous Parking and Charging Management (SPCM) method.

Although parking and charging problems consider the same physical space and are intrinsically coupled, most studies tackle two problems separately. For parking problems, automation of vehicles with communication has a large potential in using the parking infrastructure efficiently and reducing the energy consumption and emissions. However, modeling the vehicle maneuver is challenging. On one hand, the vehicles can be modeled as point mass agents in a service queue, where individual kinematic constraints and the body geometry are ignored. Although these simplifications facilitate the study of macro-level traffic behavior, they suffer from two limitations: (i) the parking trajectory may not be dynamically feasible for an actual vehicle; and (ii) the inter-vehicle interaction is neglected so that the vehicles are in lack of guidance when they encounter each other with maneuvering constraints. On the other hand, directly performing the high-fidelity path planning for multiple vehicles in the tightly constrained space will make the problem computationally intractable. To balance this trade-off between speed and accuracy, certain embodiments of the disclosed technology can include a hierarchical framework as a numerical efficient implementation, where a library of dynamically feasible trajectories are pre-computed to evaluate different spot allocation policies.

For charging problems, many researchers aim to satisfy the charging and mobility needs of EVs, while efficiently using the charging infrastructure, maximizing the clean energy use, and reducing the emissions by controlling the charging time and power of the EVs. However, they often assume that EVs are successfully plugged into the chargers, though a charger may not be available especially when EVs overstay at charging spots after charging completion and block others from using them. It is possible to provide a monetary incentive for the drivers to move out of charging spots after charging completion and make the chargers available to others, but this solution relies on the driver’s uncertain behavior of compliance. Vehicle automation has a potential in facilitating the interchange of EVs at charging stations, but has not been explored fully in the literature.

Although parking and charging problems consider the same physical space and are intrinsically coupled, current research mostly studies two problems separately and proposes few simultaneous solutions for parking and charging to the best of our knowledge. Moreover, there’s a lack of integrated solutions to manage the parking and charging of vehicles for both Internal Combustion Engine (ICE) and electric types to reduce energy consumption, reduce emissions, and increase clean energy usage. Embodiments of the disclosed technology can optimize the operation of the parking and charging activities jointly. By targeting both ICE vehicles and EVs and if the vehicles are automated, embodiments can also control the vehicles along the optimal, dynamically feasible trajectories and reallocate the vehicles autonomously to reduce idling of the chargers after completion.

### BRIEF DESCRIPTION OF THE DRAWINGS

The present disclosure will be better understood from reading the following description of non-limiting embodiments, with reference to the attached drawings, wherein below:

FIG. 1 illustrates an example of a control process for parking and charging management in accordance with certain implementations of the disclosed technology; and

FIG. 2 illustrates an example of system data flow in accordance with certain implementations of the disclosed technology.

### DETAILED DESCRIPTION

Embodiments of the present disclosure may leverage Infrastructure. With sensors to detect parking/charging spot availability and real-time traffic congestion in the parking lot, the system can allocate the vehicles to optimal parking spots and assign driving trajectories to follow. With the control of chargers, the charging time and power of each vehicle can be optimized jointly with the parking management.

Embodiments of the present disclosure may leverage V2X communication. With vehicle-to-cloud (V2C) communication, the information can be gathered by the vehicles, such as the traffic condition and charger status, and sent to a central coordinator in the cloud server. After the parking allocation, trajectory generation, and charging plan are optimized, the cloud server can transmit the optimal results to the vehicles for compliance therewith.

Embodiments of the present disclosure may leverage Automated vehicles. If vehicles are deployed with self-driving controllers, vehicles can be automated to self-drive the assigned trajectories in the most energy-efficient manner. It is also possible to relocate the vehicles after charging completion so that the charger becomes available to other EVs. This may require a wireless charging mechanism or an automated plug-in and plug-out mechanism.

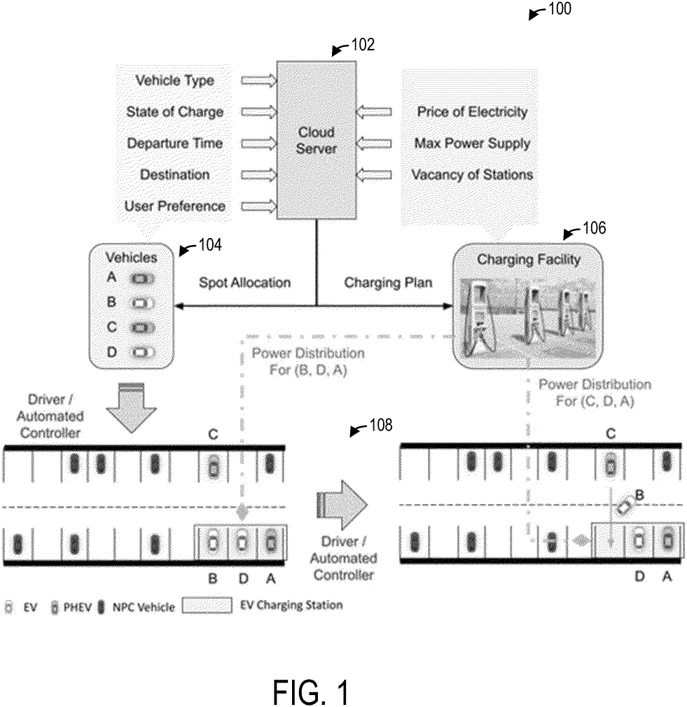

FIG. 1 illustrates an example of a control process 100 for parking and charging management in accordance with certain implementations of the disclosed technology. In the example, the control process 100 includes a cloud server 102, vehicles 104, a charging facility 106, and human drivers or automatic controllers 108.

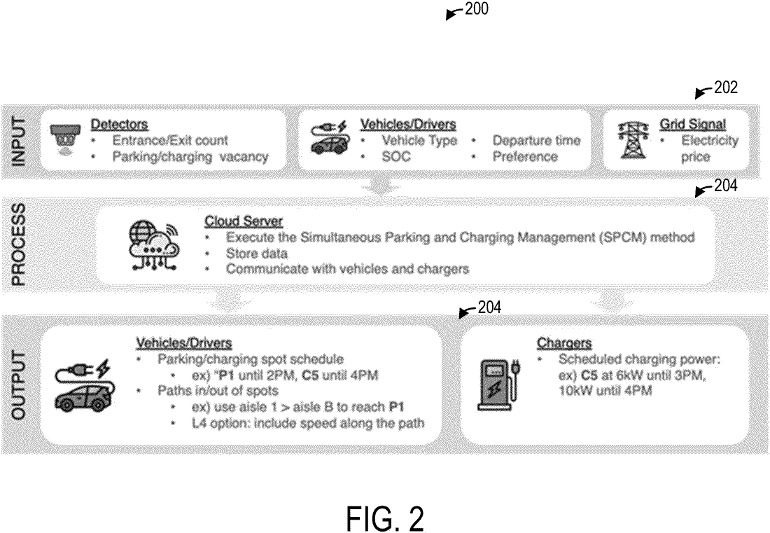

FIG. 2 illustrates an example of system data flow 200 in accordance with certain implementations of the disclosed technology. In the example, the data flow 200 includes inputs 202 such as detectors/sensors, vehicles/drivers, and grid signal. The inputs 202 may include direct measurement or indirect measurement. In certain embodiments, the detectors may be physical sensors on the infrastructure side; alternatively or in addition thereto, the detectors may be inferred by using hardware on the vehicles. For example, a vehicle entrance and/or exit may be inferred by high-precision GPS (e.g., rather than having a counter at the entrance). Also, an empty or occupied spot may be inferred by sensors on other cars (e.g., radar, lidar or ultrasound) which can detect an empty spot and communicate with the cloud system.

In the example, the data flow 200 further includes process 204 that includes operations from the cloud server 102. The data flow 200 further includes outputs 204 to vehicles/drivers and chargers.

In the example, sensors in the parking lot can collect the data on current traffic and parking/charging spot availability. The price of electricity can also be monitored in real-time.

When one of the vehicles 104 enters the parking lot, it can report to the system the necessary parameters, such as the vehicle type (e.g., ICE, EV, or Plug-in Hybrid Electric Vehicle (PHEV)), the expected departure time, and the user preference. If PH/EV, the vehicle can also report the current state of charge (SOC), desired SOC by departure, the battery capacity, and the rated charging power.

Based on observing and predicting the parking and charging demand, the cloud server 102 can solve an optimization problem and notify the vehicle(s) 104 via a mobile phone app or on the dashboard of the vehicle, for example. All vehicles 104 can be informed of their assigned time and location of the parking spot, as well as the path to reach the spot. PH/EVs can be informed on their planned charging schedule.

PH/EVs can be either assigned immediately to spots with chargers (e.g., vehicles A, B, and D at the left bottom of the figure) or tentatively assigned into parking-only spots on a waitlist (e.g., vehicle C in the figure at the left bottom of the figure). For the latter case, the system 100 can coordinate the interchange of vehicles on a charger. When one of the vehicles 104 finishes charging (e.g., vehicle B at the right bottom of the figure), it can be notified to leave the charging spot as soon as possible. When it leaves, the vehicle on a waitlist (e.g., vehicle C on the right bottom of the figure) can be notified to move in and use the now open charger.

If any of the vehicles 104 is autonomous with level 4, it can self-drive the path and velocity trajectory, which can be solved and provided by the system, and maneuver to the assigned spot. If a single vehicle in the lot is autonomous, the path can be optimized to minimize its own energy consumption based on the current traffic situation. If multiple vehicles are autonomous, their paths can be jointly optimized to minimize the aggregate energy consumption.

If a PH/EV is autonomous and needs to leave a charging spot for another PH/EV to use, it can be controlled to self-drive out of the charging spot and park at an available parking-only spot. If the incoming PH/EV is autonomous and has occupied a parking-only spot before, it can also be controlled to self-drive out of the parking spot and into the now-open charging spot.

In the example, multiple sources can send input data to the cloud server 102; the sensors in the parking lot can detect the current traffic condition and parking/charging spot availability, the vehicles 104 can transmit the information on the vehicle status and the details of parking/charging demands, and the energy grid can report the electricity price, for example.

Further in the example, the cloud server 102 can process the input data and execute the SPCM to solve for the optimal spot allocation, driving trajectory, and the charging plan, for example.

Also in the example, the cloud server 102 can send the solution to the vehicles 104 and chargers to follow. The vehicles 104 can reach the parking/charging spots per assigned schedule by human drivers or automated controllers 108 and the chargers can supply the scheduled power to the vehicles, for example.

It will be appreciated that, in certain embodiments, the disclosed SPCM may work for a set of individually-operated vehicles as well as for vehicles belonging to a fleet operator. In the latter case, a single “fleet-level” cost function is optimized (e.g., the SPCM instead of truing to make all drivers/autonomous vehicles happy, needs simply to optimize for the fleet operator).

### Examples

In a first example, a system can include at least one detector configured to provide input information, at least one electric vehicle, at least one electric vehicle charger, and a cloud server configured to execute a Simultaneous Parking and Charging Management (SPCM) method based at least in part on the input information and communicate with the at least one electric vehicle to assign a time for a certain one of the at least one electric vehicle charger based at least in part on a result of the executed SPCM method.

In a second example, a method can include using at least one sensor to collect information pertaining to current traffic conditions and parking/charging spot availability for a parking area, each of the at least one electric vehicle reporting a plurality of parameters upon entering the parking area, using a cloud server, solving an optimization problem based at least in part on the collected information and the plurality of parameters, and communicating to each of the at least one electric vehicle an assigned time and a location of a certain parking spot based on a result of the solved optimization problem.

The second example can further include using at least one sensor to monitor the price of electricity in real-time.

The plurality of parameters in the second example can include at least one selected from the group consisting of: electric vehicle type, expected departure time, and user preference.

The second example can further include communicating to at least one of the at least one electric vehicle a path for the at least one vehicle to use to reach the certain parking spot. Such example can further include optimizing the path the minimize energy consumption by the at least one electric vehicle.

The at least one electric vehicle of the second example can include a Plug-in Hybrid Electric Vehicle (PHEV) and the PHEV can be assigned immediately to a parking spot with a vehicle charger. Alternatively, the at least one electric vehicle of the second example can include a Plug-in Hybrid Electric Vehicle (PHEV) and the PHEV can be tentatively assigned to at least one parking-only spot on a waitlist. Such examples can further include communicating to one of the at least one electric vehicle an instruction to leave the certain parking spot responsive to completion of a charge cycle. Such examples can further include communicating to the PHEV an instruction to proceed to the certain parking spot.

The at least one electric vehicle of the second example can include an electric vehicle (EV) and the EV can be assigned immediately to a parking spot with a vehicle charger. Alternatively, the EV can be tentatively assigned to at least one parking-only spot on a waitlist. Such examples can further include communicating to one of the at least one electric vehicle an instruction to leave the certain parking spot responsive to completion of a charge cycle and/or communicating to the EV an instruction to proceed to the certain parking spot.

The at least one electric vehicle of the second example can include a Plug-in Hybrid Electric Vehicle (PHEV) and an electric vehicle (EV) and the PHEV and EV can each be assigned immediately to a parking spot with a vehicle charger. Alternatively, the PHEV and EV are each tentatively assigned to at least one parking-only spot on a waitlist. Such examples can further include communicating to one of the at least one electric vehicle an instruction to leave the certain parking spot responsive to completion of a charge cycle. Such examples can further include communicating to the PHEV and EV an instruction to proceed to the certain parking spot.

The plurality of parameters in the second example can include at least one selected from the group consisting of: electric vehicle type, expected departure time, and desired SoC at the end of the charge. In such example, at least one of the plurality of parameters can be provided by the user or another software based on a future driving schedule.

The second example can further include sending to the grid, electricity retailer, utility, or facility operator the current and predicted energy profile for charging the vehicles in the lot. Such example can further include the grid, electricity retailer, utility, or facility operator software accepting the request or deciding to reach a consensus on a different profile with the SPCM. Such example can further include the SPCM re-computing the charging strategies for each vehicle.

Aspects of the disclosure may operate on particularly created hardware, firmware, digital signal processors, or on a specially programmed computer including a processor operating according to programmed instructions. The terms controller or processor as used herein are intended to include microprocessors, microcomputers, Application Specific Integrated Circuits (ASICs), and dedicated hardware controllers.

One or more aspects of the disclosure may be embodied in computer-usable data and computer-executable instructions, such as in one or more program modules, executed by one or more computers (including monitoring modules), or other devices. Generally, program modules include routines, programs, objects, components, data structures, and so on, that perform particular tasks or implement particular abstract data types when executed by a processor in a computer or other device. The computer executable instructions may be stored on a computer readable storage medium such as a hard disk, optical disk, removable storage media, solid state memory, Random Access Memory (RAM), etc. As will be appreciated by one of skill in the art, the functionality of the program modules may be combined or distributed as desired in various aspects. In addition, the functionality may be embodied in whole or in part in firmware or hardware equivalents such as integrated circuits, FPGAs, and the like.

Particular data structures may be used to more effectively implement one or more aspects of the disclosure, and such data structures are contemplated within the scope of computer executable instructions and computer-usable data described herein.

The disclosed aspects may be implemented, in some cases, in hardware, firmware, software, or any combination thereof. The disclosed aspects may also be implemented as instructions carried by or stored on one or more or computer-readable storage media, which may be read and executed by one or more processors. Such instructions may be referred to as a computer program product. Computer-readable media, as discussed herein, means any media that can be accessed by a computing device. By way of example, and not limitation, computer-readable media may comprise computer storage media and communication media.

Computer storage media means any medium that can be used to store computer-readable information. By way of example, and not limitation, computer storage media may include RAM, ROM, Electrically Erasable Programmable Read-Only Memory (EEPROM), flash memory or other memory technology, Compact Disc Read Only Memory (CD-ROM), Digital Video Disc (DVD), or other optical disk storage, magnetic cassettes, magnetic tape, magnetic disk storage or other magnetic storage devices, and any other volatile or nonvolatile, removable or non-removable media implemented in any technology. Computer storage media excludes signals per se and transitory forms of signal transmission.

Communication media means any media that can be used for the communication of computer-readable information. By way of example, and not limitation, communication media may include coaxial cables, fiber-optic cables, air, or any other media suitable for the communication of electrical, optical, Radio Frequency (RF), infrared, acoustic or other types of signals.

As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property. The terms “including” and “in which” are used as the plain-language equivalents of the respective terms “comprising” and “wherein.” Moreover, the terms “first,” “second,” and “third,” etc. are used merely as labels, and are not intended to impose numerical requirements or a particular positional order on their objects.

This written description uses examples to disclose the invention, including the best mode, and also to enable a person of ordinary skill in the relevant art to practice the invention, including making and using any devices or systems and performing any incorporated methods. The patentable scope of the invention is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims.

1. A system, comprising:
at least one detector configured to provide input information;
at least one electric vehicle;
at least one electric vehicle charger; and
a cloud server configured to:
execute a Simultaneous Parking and Charging Management (SPCM) method based at least in part on the input information; and
communicate with the at least one electric vehicle to assign a time for a certain one of the at least one electric vehicle charger based at least in part on a result of the executed SPCM method.

2. A method, comprising:
using at least one sensor to collect information pertaining to current traffic conditions and parking/charging spot availability for a parking area;
each of the at least one electric vehicle reporting a plurality of parameters upon entering the parking area;
using a cloud server, solving an optimization problem based at least in part on the collected information and the plurality of parameters; and
communicating to each of the at least one electric vehicle an assigned time and a location of a certain parking spot based on a result of the solved optimization problem.

3. The method of claim 2, further comprising using at least one sensor to monitor the price of electricity in real-time.

4. The method of claim 2, wherein the plurality of parameters includes at least one selected from the group consisting of: electric vehicle type, expected departure time, and user preference.

5. The method of claim 2, further comprising communicating to at least one of the at least one electric vehicle a path for the at least one vehicle to use to reach the certain parking spot.

6. The method of claim 5, further comprising optimizing the path the minimize energy consumption by the at least one electric vehicle.

7. The method of claim 2, wherein the at least one electric vehicle includes a Plug-in Hybrid Electric Vehicle (PHEV) and further wherein the PHEV is assigned immediately to a parking spot with a vehicle charger.

8. The method of claim 2, wherein the at least one electric vehicle includes a Plug-in Hybrid Electric Vehicle (PHEV) and further wherein the PHEV is tentatively assigned to at least one parking-only spot on a waitlist.

9. The method of claim 8, further comprising communicating to one of the at least one electric vehicle an instruction to leave the certain parking spot responsive to completion of a charge cycle.

10. The method of claim 9, further comprising communicating to the PHEV an instruction to proceed to the certain parking spot.

11. The method of claim 2, wherein the at least one electric vehicle includes an electric vehicle (EV) and further wherein the EV is assigned immediately to a parking spot with a vehicle charger.

12. The method of claim 2, wherein the at least one electric vehicle includes an electric vehicle (EV) and further wherein the EV is tentatively assigned to at least one parking-only spot on a waitlist.

13. The method of claim 12, further comprising communicating to one of the at least one electric vehicle an instruction to leave the certain parking spot responsive to completion of a charge cycle.

14. The method of claim 13, further comprising communicating to the EV an instruction to proceed to the certain parking spot.

15. The method of claim 2, wherein the at least one electric vehicle includes a Plug-in Hybrid Electric Vehicle (PHEV) and an electric vehicle (EV) and further wherein the PHEV and EV are each assigned immediately to a parking spot with a vehicle charger.

16. The method of claim 2, wherein the at least one electric vehicle includes a Plug-in Hybrid Electric Vehicle (PHEV) and an electric vehicle (EV) and further wherein the PHEV and EV are each tentatively assigned to at least one parking-only spot on a waitlist.

17. The method of claim 16, further comprising communicating to one of the at least one electric vehicle an instruction to leave the certain parking spot responsive to completion of a charge cycle.

18. The method of claim 17, further comprising communicating to the PHEV and EV an instruction to proceed to the certain parking spot.

19. The method of claim 2, wherein the plurality of parameters includes at least one selected from the group consisting of: electric vehicle type, expected departure time, and desired SoC at the end of the charge.

20. The method of claim 19, wherein at least one of the plurality of parameters is provided by the user or another software based on a future driving schedule.

21. The method of claim 2, further comprising:
sending to the grid, electricity retailer, utility, or facility operator the current and predicted energy profile for charging the vehicles in the lot;
the grid, electricity retailer, utility, or facility operator software accepting the request or deciding to reach a consensus on a different profile with the SPCM; and
the SPCM re-computing the charging strategies for each vehicle.
